(19) United States
(12) Patent Application Publication
(10) Pub. No.: US 2018/0128450 A1
(43) Pub. Date: May 10, 2018

(54) SUSPENDED LUMINAIRE WITH ELONGATED LENS

(71) Applicant: GE Lighting Solutions, LLC, East Cleveland, OH (US)

(72) Inventors: Mark Edward KAMINSKI, East Cleveland, OH (US); Alex PRICE, East Cleveland, OH (US); Jeremy YON, East Cleveland, OH (US); David WANFONG, Lachine (CA); Steve GERMAIN, Lachine (CA); Matthew A. BUGENSKE, East Cleveland, OH (US)

(21) Appl. No.: 15/343,706

(22) Filed: Nov. 4, 2016

(51) Int. Cl. F21V 13/12; F21S 8/06; F21V 17/16; F21V 5/04; F21V 7/04; F21V 3/04; F21V 5/00; F21V 29/503; F21V 29/508; F21V 29/83; F21V 29/70

(52) U.S. Cl. CPC F21V 13/12; F21S 8/06; F21V 17/16; F21V 5/04; F21V 7/04; F21V 29/70; F21V 5/008; F21V 29/503; F21V 29/508; F21V 29/83; F21V 3/0445

(57) ABSTRACT

Suspended lighting fixtures are described that include one or more light sources and a lens component that minimizes and/or eliminates unwanted shadows caused by debris such as dust and/or insects. In some embodiments, the suspended light fixture includes a housing, at least one light source operably connected to the housing, and a lens element operably connected to the housing. The lens element includes a tip portion and a debris hiding feature, wherein the debris hiding feature at least minimizes undesirable shadows that occur when light emitted from the at least one light source impinges on the debris that settled on an interior of the tip portion.

### FIELD OF THE INVENTION

The present disclosure generally relates to suspended lighting fixtures such as luminaries arranged to accept lighting elements. More particularly, in some embodiments suspended lighting fixtures have light emitting diode (LED) light sources and include an elongated lens component that minimizes and/or eliminates unwanted shadows caused by debris such as dust and/or insects.

### BACKGROUND

Lighting fixtures, such as Troffer-style lighting fixtures, are ubiquitous in commercial office and industrial spaces and are typically designed to have a spatially convenient and aesthetically pleasing linear appearance. Thus, many of these lighting fixtures house linear elongated fluorescent light bulbs that span the length of the troffer. Such lighting fixtures can be mounted to or suspended from ceilings, and some can be at least partially recessed into the ceiling, with the back side of the troffer protruding into the plenum area above the ceiling

Troffers and other commercial lighting fixtures have recently been developed that utilize light-emitting diodes (LEDs) as their light source. LEDs are solid state devices that convert electric energy to light and generally include one or more active regions of semiconductor material interposed between oppositely doped semiconductor layers. When a bias is applied across the doped layers, holes and electrons are injected into the active region where they recombine to generate light. The light produced in the active region is then emitted from surfaces of the LED. The LEDs have characteristics that make them desirable for many lighting applications, such as for use in troffers, that were previously the realm of incandescent or fluorescent lights. With regard to other types of light sources, incandescent lights are energy-inefficient because approximately ninety percent of the electricity they consume is released as heat instead of light. Fluorescent light bulbs are more energy efficient than incandescent light bulbs by a factor of about 10, but are still relatively inefficient. In contrast, LEDs can emit the same luminous flux as incandescent and fluorescent lights using a fraction of the energy. In addition, LEDs can have a significantly longer operational lifetime than incandescent light bulbs and fluorescent bulbs. The increased efficiency and extended lifetime of LEDs is attractive to many lighting suppliers and has resulted in their LED lights being used in place of conventional lighting in many different applications.

LEDs can be arranged in many different ways in the above mentioned lighting fixtures, with some fixtures having LEDs incorporated into a linear lighting device and having a structure similar to a florescent tube. These “tube” LED devices can resemble a linear florescent bulb and have electrodes and pins at both ends of their linear structure. Such suspended lighting fixtures, which may include linear lighting devices like LEDs, typically include a cover lens structure that is close or near to the LED light sources in order to maximize the light output. However, in some cases, a very high brightness level is achieved that is undesirable due to glare issues and the like. In addition, debris and/or insects may infiltrate and/or be trapped in the lens cavity, which is formed between an inner surface of cover lens and the LED light source(s) of the luminaire structure. In particular, such debris and/or insects may settle or be deposited on an interior portion(s) of the cover lens in a position to impede and/or block a portion of the light output from the light sources, and/or to create unwanted shadows.

Therefore, it would be advantageous to provide an LED luminaire structure and/or assembly having a cover lens structure configure to lower the brightness level while also including features that minimize and/or remove and/or hide debris and/or insects that can be trapped in the lens cavity.

### BRIEF DESCRIPTION OF THE DRAWINGS

Features and advantages of some embodiments, and the manner in which the same are accomplished, will become more readily apparent with reference to the following detailed description taken in conjunction with the accompanying drawings, which illustrate exemplary embodiments (not necessarily drawn to scale), wherein:

FIG. 1 is a side perspective view of an embodiment of a lighting fixture in accordance with some embodiments of the disclosure;

FIG. 2 is a cross-sectional side view of the lighting fixture of FIG. 1 taken along dotted line 2-2 in accordance with some embodiments of the disclosure;

FIGS. 3A, 3B and 3C are a cross-sectional side views of luminaries that each have an elongated lens element in accordance with some embodiments of the disclosure;

FIG. 4 is a cross-sectional side view of a lighting fixture having an elongated lens element in accordance with some embodiments;

FIG. 5A is a top perspective view of a suspended luminaire having a ventilated lens element in accordance with some embodiments;

FIG. 5B is a partial bottom perspective view of the suspended luminaire of FIG. 5A in accordance with some embodiments;

FIG. 5C is a cross-sectional side view of the suspended luminaire of FIG. 5A in accordance with some embodiments;

FIG. 6 is a cross-sectional side view of a luminaire having a clear interior lens element in accordance with some embodiments; and

FIG. 7 is a cross-sectional side view of a luminaire having a clear film insert in accordance with some embodiments.

### DETAILED DESCRIPTION

Reference now will be made in detail to illustrative embodiments, one or more examples of which are illustrated in the drawings. Like components and/or items in the various drawings are identified by the same reference number and each example is provided by way of explanation only and thus does not limit the invention. In fact, it will be apparent to those skilled in the art that various modifications and/or variations can be made without departing from the scope and/or spirit of the invention. For instance, in many cases features illustrated or described as part of one embodiment can be used with another embodiment to yield a further embodiment. Thus, it is intended that the present disclosure covers such modifications and variations as come within the scope of the appended claims and their equivalents.

Embodiments described herein relate to suspended lighting fixtures, such as luminaries, that include one or more light sources and a lens component. More particularly, some embodiments of a suspended lighting fixture include one or more light emitting diode (LED) light sources and an elongated lens component that is configured to minimize and/or eliminate unwanted shadows caused by debris, such as dust and/or insects. In some embodiments, the elongated lens component is characterized by an increased surface area as compared to lens components of conventional luminaries, which results in decreased brightness as compared to such conventional luminaries, and that also results in minimizing glare. Some implementations feature a generally V-shaped elongated lens component, and this configuration enables utilization of various internal lens component and/or optical features. For example, a clear interior lens component and/or a clear film insert may be included within the elongated lens component to minimize and/or eliminate unwanted shadows caused by debris (i.e., dust and/or insects), which have infiltrated the interior portion of the suspended luminaire. Some embodiments also include additional features or aspects, such as one or more reflector wings which can be utilized to control and/or direct at least a portion of the light emitted by the light source to a particular downward direction which otherwise would be emitted sideways and/or upwardly. Disclosed embodiments therefore solve the technological problem of how to provide a low-cost, suspended light fixture that reduces brightness resulting in less glare than conventional luminaries, and that eliminates and or minimizes unwanted and/or unsightly shadows caused by debris (such as dust and/or insects) which has infiltrated the interior portion(s) of the luminaire.

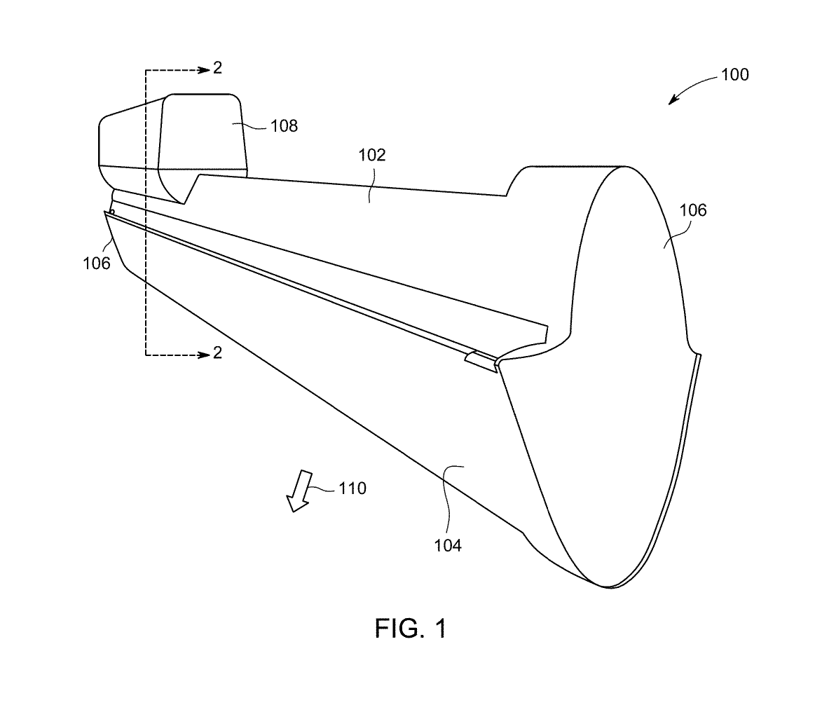

FIG. 1 is a side perspective view of an embodiment of a lighting fixture 100 according to the present disclosure. The lighting fixture 100 includes a luminaire housing 102 which imparts a linear shape to the fixture, an elongated lens element 104, and one or more end caps 106. The lighting fixture 100 may hang from a ceiling (not shown) via a suspension support structure 108, which is configured to support the lighting fixture spatially in place at least some distance away from, for example, a mounting surface of the ceiling. It should be understood, however, that the lighting fixture 100 could also be mounted on another surface in other orientations, such as mounted on a wall or floor. The suspension support structure 108 may also house or conceal a power supply and/or driver circuitry and/or a power cord(s) and/or electrical connection elements and/or other electronics (not shown). In addition, the luminaire housing 102 houses one or more sources of light (not shown), such as one or more light-emitting diodes (LEDs), which produce light that is emitted through the elongated lens element 104 in a generally downward direction indicated by arrow 110. It should be understood, however, that in most implementations light is emitted outwardly through the elongated lens 104 in various different directions. The suspension support structure 108, luminaire housing 102 and end caps 106 may be made of a variety of materials, including but not limited to metals (such as aluminum), plastics, acrylic, polyethylene, various other polymers and/or a composite material and/or combinations thereof, and may be opaque.

In some embodiments, the elongated lens 104 is generally V-shaped, and may help to impart a rigid structure to the lighting fixture 100. For example, the elongated lens 104 may be formed from a rigid or semi-rigid polycarbonate (PC) material, or a glass material, or Poly(methyl methacrylate) (PMMA), which is also known as acrylic or acrylic glass (having known trade names such as Plexiglas, Acrylite, Lucite, and Perspex, among several others), or any other suitable transparent or semi-transparent or diffuse material. The elongated lens may also include various types of diffusion levels, which may depend on the type of use (for example, office use, or household use, or outdoor use). The elongated lens 104 may also include one or more optical elements which may, for example, direct and/or collimate and/or focus and/or narrow beams of light emitted from the light source in the direction of the arrow 110, and may be formed via any number of processes, including but not limited to, extrusion, co-extrusion, and molding (such as injection molding).

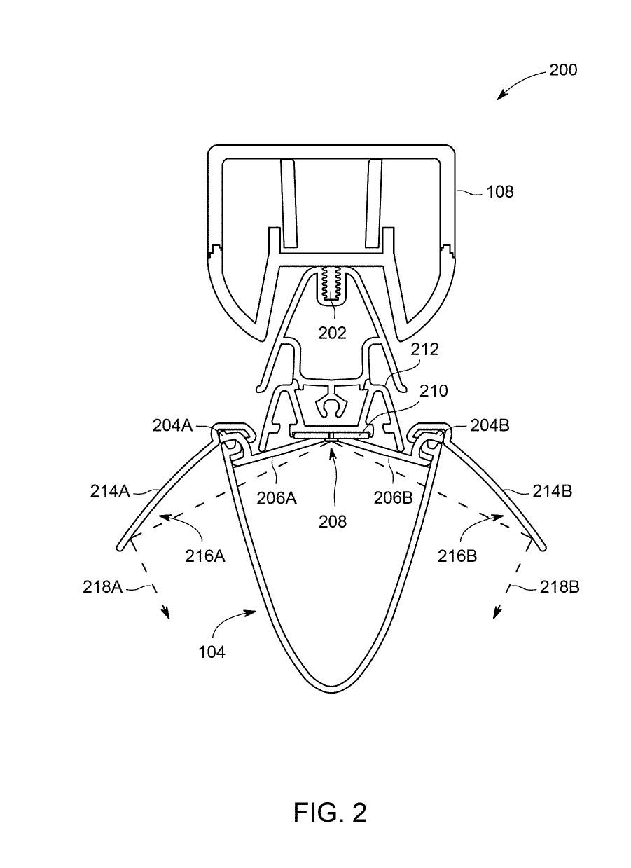

FIG. 2 is a cross-sectional side view 200 of the lighting fixture 100 taken along dotted line 2-2 of FIG. 1. In some implementations, the suspension support structure 108 may be affixed to the luminaire housing 102 by one or more connectors 202, such as a screw. As also shown, the elongated lens 104 may be snap-fit to receiving elements 204A and 204B of the reflector elements 206A and 206B, respectively. In some embodiments, the reflector elements 206A and 206B are configured to direct light from the light source 208 in a generally downward direction. The cross-section of the elongated lens 104 is generally V-shaped as shown, and is thus configured for providing an increased lens surface area as compared to conventionally-shaped lens elements (for example, C-shaped lenses) resulting in a reduction in the overall brightness of the light emitted from the light source(s) as compared to conventional light fixtures.

Referring again to FIG. 2, the LED light source 208 is shown operably connected to a heat sink 212, which may also form an internal support structure. The heat sink 212 can also be a part of a printed circuit board (PCB) 210 that is associated with the LED light source 208. It should be understood that, in some embodiments the lighting fixture includes a plurality of LED light sources, and such LED light sources may be, for example, high-powered LEDs (HP-LEDs) or high-output LEDs (HO-LEDs), and in such cases a heat sink 212 may be required to dissipate heat. Thus, in some embodiments, the heat sink 212 provides thermal dissipation functionality to the back side of the PCB board 210. The heat sink 212 may be made of, for example, a conductive metal material, or a thermal rubber material, or a thermal composite material. In addition, such components (for example, the PCB and the heat sink/internal support structure) may be screwed or riveted together, or otherwise may be affixed together by a thermal glue or other material(s) that are capable of conducting heat and/or dissipating heat. For example, in some implementations, heat-conducting fasteners (not shown) may be used to connect, for example, the wing reflector elements 214A and 214B to the reflector elements 206A, 206B and/or to the heat sink 212.

FIG. 2 also illustrates wing reflectors 214A and 214B, which include reflective surfaces 216A and 126B, respectively, for guiding or re-directing light from the light source 208 that is emitted through the side portions of the elongated lens 104 in a generally downward direction, as illustrated by the exemplary arrows 218A and 218B. The reflective surfaces 216A and 216B may be made from, for example, a white and/or diffuse and/or a specular reflective material. In some implementations, the wing reflectors 214A and 214B are snap-fit (as shown) to the receiving elements 204A and 204B, and may also be made of a thermally conducting metal material (such as aluminum) to aid in dissipating heat generated by the light source(s) and/or by other electronic components to the ambient air. Thus, the wing reflectors 214A and 214B may aid in controlling and/or minimizing the amount of light that would otherwise be emitted in an upward direction (for example, towards a ceiling) or a sideways direction, and in an implementation, when a specular reflective coating is utilized, can aid in collimating the light emitted from the elongated lens 104 to form a narrow beam.

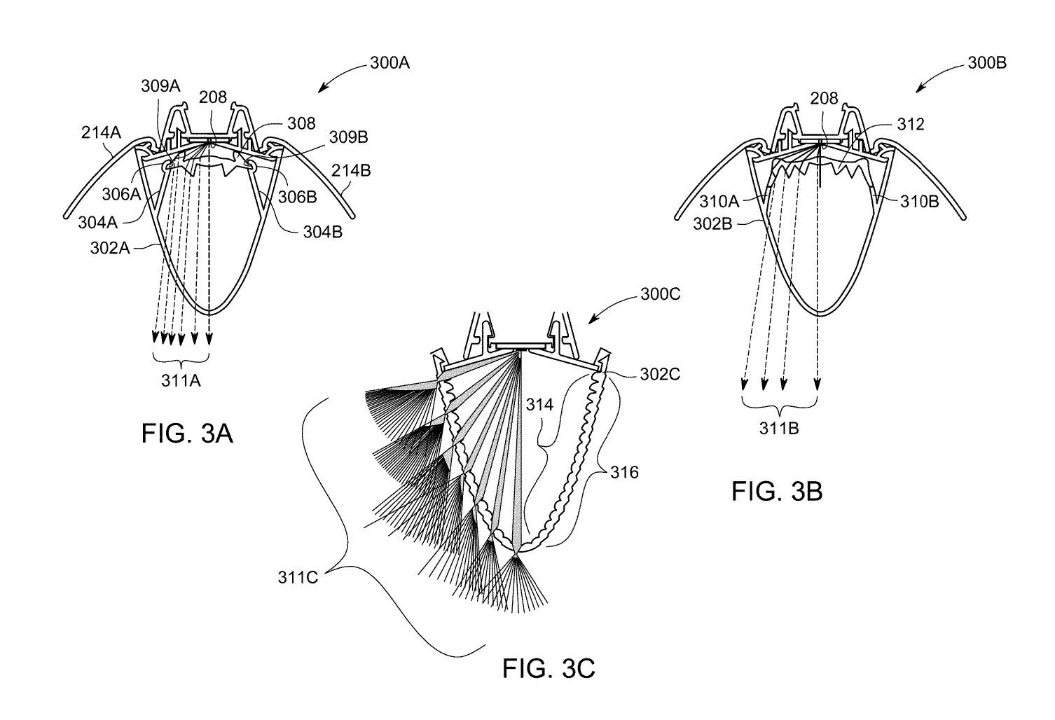

FIGS. 3A, 3B and 3C are a cross-sectional side views of several embodiments of a luminaire 300A, 300B and 300C having an elongated lens element 302A, 302B and 302C, respectively, in accordance with the disclosure. In FIG. 3A, the elongated lens element 302A is generally V-shaped and includes internal support arms 304A and 306B that protrude inwardly and upwardly towards the light source 208. In some implementations, integrated internal support arms 304A and 304B each have an associated support head 306A and 306B which includes a slot or trough. A collimating optical element 308 has tabs 309A and 309B that are configured to be snap-fit (as shown) into the slots of the support heads 306A, 306B, or otherwise attached. Thus, the collimating optical element 308 is affixed between a first interior surface and a second interior surface of the elongated lens element, as shown. The collimating optical element 308 may be configured to collimate light from the light source 208 in a substantially downward direction (as shown by the example dotted line arrows 311).

The elongated lens element 302B shown in FIG. 3B is has a generally V-shape and includes short internal support arms 310A and 310B which can be co-extruded with a collimating optical element 312. The collimating optical element 312 may collimate or align light from the light source 208 (as shown by the example dotted line arrows 311B) in a slightly different manner than the light directed by the collimating optical element 308 of FIG. 3A. It should be understood, however, that the collimating optical elements 308 and 312 can be designed to produce any desired alignment of light emitted from the light source 208.

The illustrative luminaire embodiment 300C shown in FIG. 3C also includes an elongated lens element 302C having a generally V-shape, but without any internal support arms attached to a collimating optical element. Instead, the elongated lens element 302C includes a plurality of internal optical elements 314 and external optical elements 316 which are configured to direct, align and/or filter light emitted from the light source 208 (as shown by the example light arrays 311C). It should be understood that the optical features depicted in FIGS. 3A, 3B and 3C could be utilized alone or in any combination, as desired. For example, some embodiments may utilized only internal optical elements 314, whereas some other embodiments may utilized only external optical elements 316, and yet a further embodiments may utilize both.

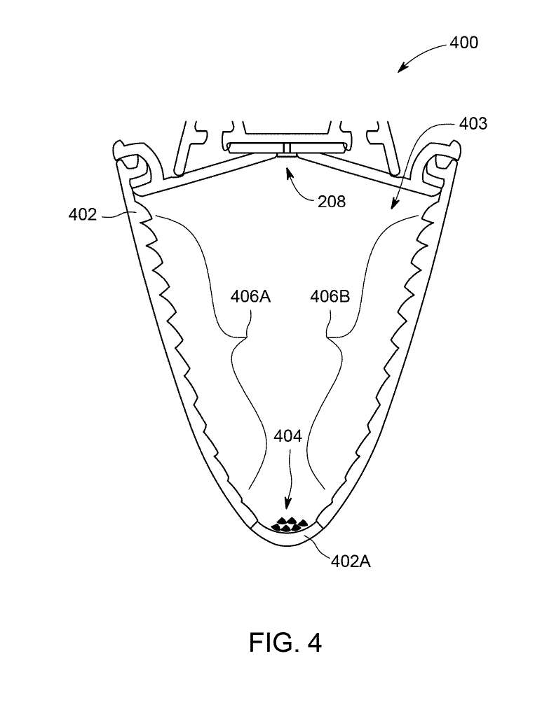

FIG. 4 is a cross-sectional side view of a luminaire 400 having an elongated lens element 402 in accordance with some embodiments. In case of a suspended luminaire having an elongated lens element 402 that is not completely sealed when assembled, it is possible for debris 404, such as dust and/or insects, to infiltrate or otherwise get into the interior portion or cavity 403 that is formed between a bottom portion of the luminaire housing supporting the light source(s) 208 and the elongated lens. This debris may then accumulate or settle in an interior bottom portion of the elongated lens due to gravity and produce undesirable and/or unwanted shadows when light from the light source 208 impinges thereon. Thus, in some embodiments, an opaque tip portion 402A is extruded (or co-extruded) when the elongated lens 402 is formed. In some embodiments, the opaque tip 402A is a debris hiding feature that prevents or at least minimizes unwanted and/or undesirable shadows which otherwise would be caused by the debris 404, so that such debris is hidden and/or not visible and/or barely visible to an observer. In some embodiments, the opaque tip portion 402A is made of a thick white plastic material or the like, which does not allow light to pass through, and thus to an observer presents as a dark, non-transparent strip along the lens portion of the lighting fixture 400 when light emitted from the light source 208 impinges on the elongated lens element 402. In the example shown in FIG. 4, the dark strip may run the length (or substantially the entire length) of the elongated lens element 402 of the suspended luminaire. However, in some other embodiments, the opaque tip 402A may be made of a heavy diffuse material (or a lighter diffuse material) that permits a portion of the light emitted from the light source 208 to pass through. Thus, in this case an observer would see some shadow(s) on the lowest part(s) of a luminaire, for example, suspended from a ceiling when light from the light source impinges on the debris in those interior portion(s) where debris is present. Thus, it should be understood that various types of materials could be used to achieve different light diffusion levels and/or different desired effect(s) with regard to hiding debris and/or allowing some shadows caused by such debris.

Referring again to FIG. 4, the elongated lens element 402 has a generally V-shape, but it should be understood that the opaque tip 402A may be included with lens elements having other shapes, such as a generally U-shaped lens structure to obtain the same debris-hiding result. In addition, as shown the elongated lens element 402 of FIG. 4 includes optional interior optical elements 406A and 406B, which may be utilized to collimate light emitted from the light source 208, as explained above.

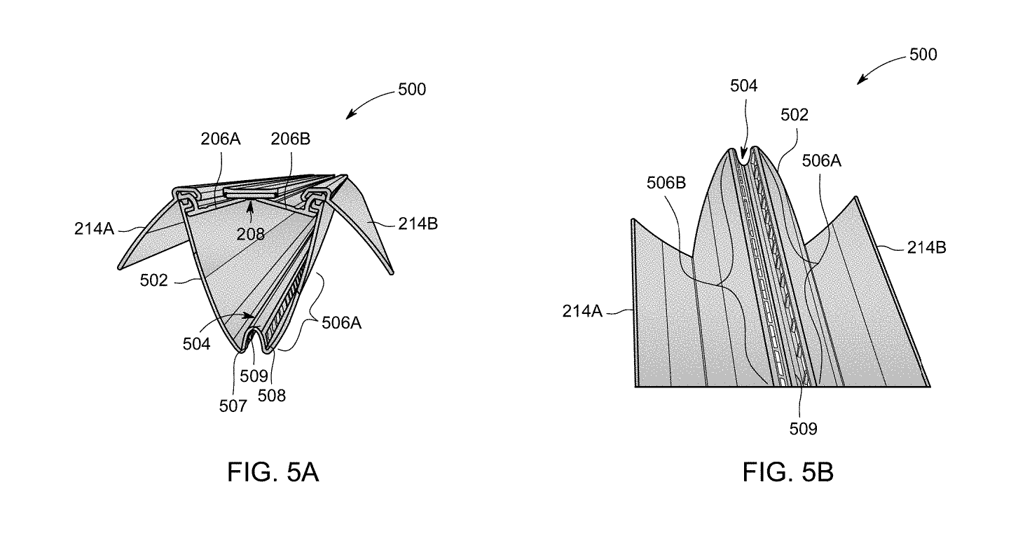

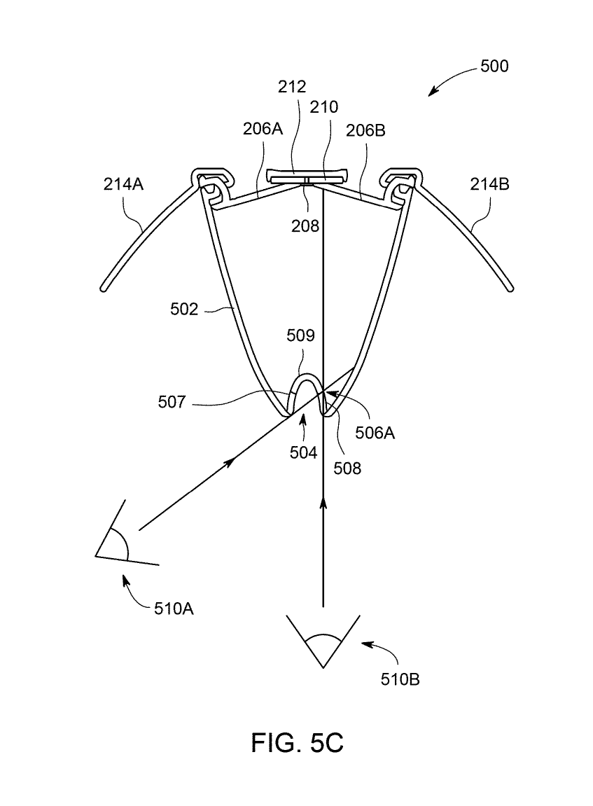

FIG. 5A is a top perspective view of a suspended luminaire 500 that includes a ventilated lens element 504 in accordance with some embodiments, and FIG. 5B is a partial bottom perspective view of the suspended luminaire 500 of FIG. 5A. FIG. 5C is a cross-sectional side view of the suspended luminaire of FIG. 5A.

In the example shown in FIGS. 5A-5C, the suspended luminaire 500 includes an elongated lens element 502 that is generally V-shaped, and includes a ventilated lens element 504 in a bottom portion or tip area that has a generally inverted U-shape (as shown). The ventilated lens element 504 constitutes another implementation of a debris hiding feature. In particular, the side walls of the ventilated lens element 504 include a plurality of ventilation holes, wherein a first plurality of the ventilation holes 506A are formed on a first side wall 508 of the ventilated lens element 504, and a second plurality of ventilation holes 506B are formed on a second side wall 507 of the ventilated lens element. In some embodiments, a diffuse central portion 509 is formed between the first side wall 508 and the second side wall 507, which may block all or substantially all of the light emitted from the light source(s) 208. The ventilation holes 506A and 506B may be provided on the entire length of the ventilated lens element 504 (as shown) along the bottom or tip portion of the elongated lens element 502, or may be provided substantially along the length of the lens element. These ventilation holes 506A, 506B are configured to permit debris, such as dust and/or insects, to pass through and out of the luminaire 500 instead of accumulating in the bottom portion or tip of the elongated lens structure. Accordingly, ventilated lens element 504 minimizes and/or eliminates unwanted or undesirable shadows that otherwise would be caused by such debris when light form the light source 208 impinges thereon.

In addition, as shown most clearly in FIG. 5C the ventilation holes 506A and 506B are configured so that observers 510A, 510B, standing under the suspended luminaire 500 with a ventilated lens element 504, are unable to directly view the light source(s) 208. In some embodiments, a central diffuse portion 509 of the ventilated lens element 504 may block all or substantially all of the light emitted from the light source(s) 208, or otherwise mask light from the light source(s). In addition, the ventilation holes 506A and 506B are configured to lie in a plane that is almost or substantially perpendicular to the plane in which light from the light source is emitted, and this harsh angle prevents direct line of sight to the light source. For example, observer 510A can see an internal portion of the elongated lens element 502, but has no direct line of sight to the light source(s) 208. Likewise, no direct line of sight to the light source 208 exists for the observer 510B. In fact, no line of sight exists from any position outside the elongated lens element 502 to the light source(s) 208. The observers 510A and 510B may only be able to see light passing through a portion of the ventilation holes 506A and/or 506B which has been reflected internally by the elongated lens element 502.

In some embodiments, the ventilated lens element 504 may also be made of the same diffuse material as the rest of the elongated lens 502 so as to allow at least a portion of the light emitted from the light source(s) 208 to pass through. In addition, it should be understood that the ventilated lens element 504 as shown can be modified and/or changed and still provide the same functionality. For example, a ventilated lens structure may be a different shape (other than an inverted U-shape) and can include ventilation holes of various and/or different shapes. Such ventilation holes also could be formed only on a first or only on a second side wall, and/or may be formed in one or more patterns.

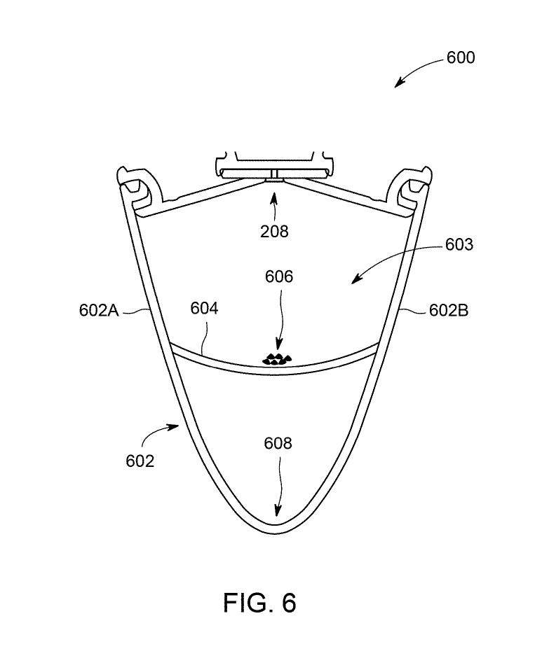

FIG. 6 is a cross-sectional side view of a luminaire 600 having an interior lens element 604 in accordance with some embodiments. As explained above, in the case of a suspended luminaire having an elongated lens element 602 that is not completely sealed when assembled, it is possible for debris 606 (such as dust and/or insects) to infiltrate or otherwise get into the interior portion or cavity 603 below the light source(s) 208 and a bottom tip portion 608 of the elongated lens. In order to prevent the accumulation of debris in the interior bottom portion 608 of the lens element, which would result in undesirable and/or unwanted shadows when light from the light source 208 impinges thereon, a lens element 604, which may be clear or diffuse, is provided in the interior portion of the lens 602, from a first side wall 602A to the second side wall 602B (as shown). Thus, the lens element 604 is another implementation of a debris hiding feature, and may be co-extruded along with the other portions of the elongated lens 602 during manufacture. Such an interior lens element 604 functions to separate the debris 606 (which settles thereon as shown, under gravity) from the interior surface of the tip portion 608 when the suspended luminaire 600 is in use. The distance between the debris 606 and the tip portion 608 serves to minimize or eliminate undesirable shadows from the tip portion 608 (that otherwise would result from light impinging on the debris that would have gathered or settled on the interior surface of the tip portion 608). In some embodiments, the elongated lens 602 is a heavy diffuse lens and does not contain any optical elements, as shown. However, in other embodiments, the elongated lens 602 may be made of a less diffuse material and/or may include any or all combinations of optical elements described herein.

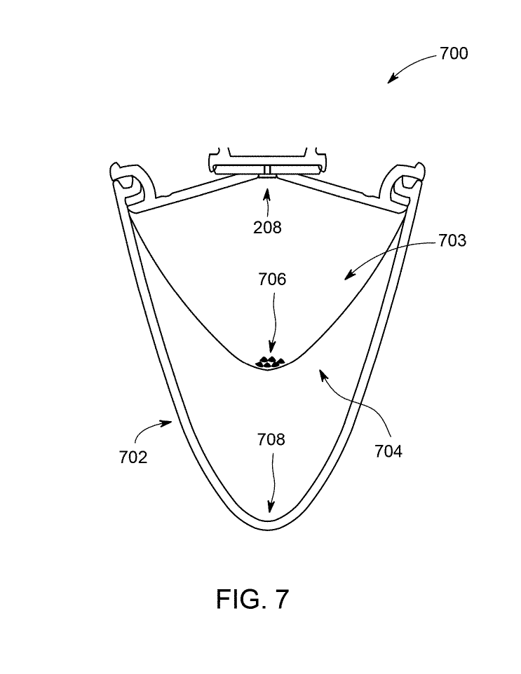

FIG. 7 is a cross-sectional side view of a suspended luminaire 700 having a film insert 704 in accordance with some embodiments. Again, as mentioned above, in the case of a suspended luminaire having an elongated lens element 702 that is not completely sealed when assembled, it is possible for debris 706 to infiltrate or otherwise get into the interior portion or cavity 703 below the light source(s) 208 and a bottom tip portion 708 of the elongated lens. This debris can settle and/or accumulate under the force of gravity in the bottom portion 708 resulting in unsightly shadows when light from the light source 208 impinges thereon, which would be visible by an observer looking upwards at the luminaire. Thus, in order to prevent debris from accumulating in the interior bottom portion 708, a film insert 704 (which may be clear or diffuse) is attached at points 710A and 710B during assembly of the luminaire 700, which forms a generally U-shaped clear barrier within the interior portion 703 as shown. The film insert 704 is another implementation of a debris hiding feature, which catches and/or accumulates the debris 706 (which settles thereon), and thus separates it from the interior surface of the tip portion 708. The separation distance of the debris 706 from the tip portion 708 serves to minimize or eliminate undesirable shadows that otherwise would result from light impinging on the debris from the light source(s) 208 that would have gathered or settled on the interior surface of the tip portion 708. In some embodiments, the elongated lens 702 is a heavily diffuse lens and does not contain any optical elements, as shown. However, in other embodiments, the elongated lens 702 may be made of a less diffuse material and/or include one or more optical element described herein.

Thus, various embodiments described herein include a debris hiding feature that functions to minimize and/or eliminate unsightly or undesirable or unwanted shadows on a lens element of a suspended luminaire. In some embodiments, an elongated lens component provides an increased surface area as compared to lens components of conventional luminaries, which results in decreased brightness and minimizes glare. Some implementations of a suspended luminaire disclosed herein feature a generally V-shaped elongated lens element or component, which in some embodiments may include one or more optical features for collimating light emitted from the one or more light sources. In addition, interior lens components, such as an interior lens and/or a clear film insert, may be included that function to minimize and/or eliminate unwanted shadows caused by debris (i.e., dust and/or insects), which have infiltrated the interior portion of the suspended luminaire. Some embodiments may also include additional features or aspects, such as one or more reflector wings which can be utilized to control and/or direct at least a portion of the light emitted by the luminaire in a desired direction, for example a generally downward direction for a luminaire suspended from a ceiling, which otherwise would be emitted in a sideways and/or upward direction. Disclosed embodiments therefore solve the technological problem of how to provide a low-cost, suspended light fixture that eliminates and/or minimizes unwanted and/or unsightly shadows caused by debris (such as dust and/or insects which infiltrated the interior portion(s) of the luminaire), and that reduces brightness resulting in less glare than conventional luminaries.

It should be understood that the above descriptions and/or the accompanying drawings are not meant to imply a fixed order or sequence of steps for any process or method of manufacture referred to herein. Thus, any disclosed process may be performed in any order that is practicable, including but not limited to simultaneous performance of one or more steps that are indicated as sequential.

Although the present invention has been described in connection with specific exemplary embodiments, it should be understood that various changes, substitutions, modifications and/or alterations apparent to those skilled in the art can be made to the disclosed lighting fixture embodiments and/or elongated lens elements without departing from the spirit and scope of the invention as set forth in the appended claims.

What is claimed is:

1. A suspended light fixture, comprising:
a housing;
at least one light source operably connected to the housing; and
a lens element operably connected to the housing, the lens element comprising a tip portion and a debris hiding feature, wherein the debris hiding feature at least minimizes undesirable shadows that occur when light emitted from the at least one light source impinges on the debris that settled on an interior of the tip portion.

2. The suspended light fixture of claim 1, wherein the debris hiding feature comprises an opaque tip portion of the lens element.

3. The suspended light fixture of claim 1, wherein the debris hiding feature comprises a ventilated tip portion of the lens element.

4. The suspended light fixture of claim 3, wherein the ventilated tip portion includes a plurality of ventilation holes configured to prevent direct line of sight to the at least one light source.

5. The suspended light fixture of claim 1, wherein the debris hiding feature comprises a clear film insert positioned between the at least one light source and the tip portion of the lens element.

6. The suspended light fixture of claim 1, wherein the debris hiding feature comprises a clear lens element positioned between the at least one light source and the tip portion of the lens element.

7. The suspended light fixture of claim 1, wherein the lens element comprises an elongated lens having a generally V-shaped cross section.

8. The suspended light fixture of claim 7, wherein the elongated lens comprises at least one of a plurality of interior optical elements and a plurality of exterior optical elements.

9. The suspended light fixture of claim 1, further comprising a first reflector element having a first receiving element on a first distal end and a second reflector element having a second receiving element on a second distal end, the first and second reflector elements connected to the housing on either side of the at least one light source and operable to reflect light in a generally downward direction.

10. The suspended light fixture of claim 8, further comprising a first wing reflector element connected to the first receiving element and a second wing reflector element connected to the second receiving element.

11. The suspended light fixture of claim 1, further comprising a collimating optical element affixed between a first interior surface and a second interior surface of the lens element and operable collimate light emitted from the at least one light source.

12. A suspended luminaire, comprising:
a housing;
a light emitting diode (LED) printed circuit board connected to the housing and comprising at least one LED light source; and
an elongated lens element operably connected to the housing, the elongated lens element comprising a debris hiding feature that at least minimizes undesirable shadows from occurring when debris accumulates on a tip portion of the elongated lens element.

13. The suspended luminaire of claim 12, wherein the debris hiding feature comprises an opaque tip portion of the elongated lens element.

14. The suspended luminaire of claim 11, wherein the debris hiding feature comprises a ventilated tip portion of the elongated lens element.

15. The suspended light fixture of claim 14, wherein the ventilated tip portion comprises a plurality of ventilation holes configured to prevent direct line of sight to the at least one light source.

16. The suspended luminaire of claim 12, wherein the debris hiding feature comprises a clear film insert positioned between the at least one light source and the tip portion of the elongated lens element.

17. The suspended luminaire of claim 12, wherein the debris hiding feature comprises a clear lens element positioned between the at least one light source and the tip portion of the elongated lens element.

18. The suspended luminaire of claim 12, wherein the elongated lens element has a generally V-shaped cross section.

19. The suspended luminaire of claim 18, wherein the elongated lens element further comprises at least one of a plurality of interior optical elements and a plurality of exterior optical elements.

20. The suspended luminaire of claim 12, further comprising:
a first reflector element having a first receiving element on a first distal end; and
a second reflector element having a second receiving element on a second distal end;
wherein the first and second reflector elements are connected to the housing on a first side and a second side, respectively, of the at least one light source and are operable to reflect light in a generally downward direction.

21. The suspended luminaire of claim 20, further comprising:
a first wing reflector element connected to the first receiving element; and
a second wing reflector element connected to the second receiving element.

22. The suspended luminaire of claim 12, further comprising a collimating optical element affixed between a first interior surface and a second interior surface of the elongated lens element and operable collimate light emitted from the at least one light source.
